(19) United States
(12) Patent Application Publication
(10) Pub. No.: US 2017/0177508 A1
(43) Pub. Date: Jun. 22, 2017

(54) INFORMATION PROCESSING APPARATUS AND SHARED-MEMORY MANAGEMENT METHOD

(71) Applicant: FUJITSU LIMITED, Kawasaki-shi (JP)

(72) Inventor: Hiroshi Kondou, Yokohama (JP)

(73) Assignee: FUJITSU LIMITED, Kawasaki-shi (JP)

(21) Appl. No.: 15/341,042

(22) Filed: Nov. 2, 2016

(30) Foreign Application Priority Data
Dec. 18, 2015 (JP) 2015-247724

(51) Int. Cl. G06F 12/14; G06F 13/16

(52) U.S. Cl. CPC G06F 12/1475; G06F 13/1663; G06F 2212/1052

(57) ABSTRACT

A segment-information notifying unit in the home node notifies the number of the segment in the shared memory 43, which has been used by the faulty node, to each of the normal remote nodes, and it gives an instruction to temporarily stop the access on a per-segment basis. Then, a memory-access token setting unit sets a new token to the memory token register that corresponds to the shared memory segment that has been used by the faulty node, and it notifies the new token to each of the normal remote nodes. Then, an access resuming unit notifies each of the normal remote nodes of access resumption.

### CROSS-REFERENCE TO RELATED APPLICATION(S)

This application is based upon and claims the benefit of priority of the prior Japanese Patent Application No. 2015-247724, filed on Dec. 18, 2015, the entire contents of which are incorporated herein by reference.

### FIELD

The embodiment discussed herein is related to an information processing apparatus and a shared-memory management method.

### BACKGROUND

In information processing systems that have been used in recent years, multiple information processing apparatuses are connected via a crossbar switch, or the like. Each information processing apparatus includes multiple central processing units (CPUs), memories, hard disk drives (HDDs), or the like, and it communicates with a different information processing apparatus via a crossbar switch, or the like. Furthermore, the memories, provided in each information processing apparatus, include a local memory, which may be accessed by only the information processing apparatus, and a shared memory, which may be accessed by a different information processing apparatus.

For shared memories, the technology that uses access tokens has been developed as a technology for controlling permission for access from other information processing apparatuses. Each information processing apparatus stores, in the register, a key called a memory token for each unit area of a predetermined size in the shared memory, and it allows only the information processing apparatus, which specifies the key as an access token, to access the corresponding unit area. Furthermore, if a failure occurs in a different information processing apparatus that uses the shared memory, the information processing apparatus, including the shared memory, stores a new memory token in the register. Then, the information processing apparatus, including the shared memory, transmits the new memory token to the information processing apparatus where the failure occurs. However, the failure-occurring information processing apparatus is not allowed to receive the new memory token; therefore, even if it accesses the shared memory, the memory token does not match. Thus, it is possible to prevent access to the shared memory from the information processing apparatus where a failure occurs.

Furthermore, there is the following conventional technology with regard to access to shared resources. A new membership list is generated for each new configuration that includes a node and a resource in the system and, on the basis of it, a new epoch number is generated to clearly identify the membership that is correlative to the time when it exists. A control key is generated on the basis of the epoch number, and it is stored in each resource-control device and node of the system. If it is determined that a failure occurs in a certain node, it is removed from the membership list, and an epoch number and a control key are newly generated. If a node transmits an access request to the resource, the resource-control device compares the locally stored control key with the control key (which is transmitted together with the access request) stored in the node. Only if the two keys match, the access request is executed.

### [Patent Literature 1] Japanese Laid-open Patent Publication No. 2013-140446

[Patent Literature 2] Japanese Laid-open Patent Publication No. H9-237226

However, if a failure occurs in a certain information processing apparatus that uses the shared memory, access to the entire shared memory is temporarily stopped to reset an access token. Therefore, there is a problem in that access is interrupted due to the process to stop and resume the access to the entire shared memory even if the other normal information processing apparatuses except for the failure-occurring information processing apparatus desire to access an area in the shared memory other than the area accessed by the failure-occurring information processing apparatus.

### SUMMARY

According to an aspect of an embodiment, an information processing apparatus, that constructs an information processing system together with other information processing apparatuses and that includes a shared memory accessed by the other information processing apparatuses, includes a management-information storage region that stores management information in which each unit area of the shared memory is related to an information processing apparatus that is allowed to use each unit area; an authentication-information storage region that stores authentication information that is used to control access authentication for each unit area of the shared memory; a first notifying processor that notifies a stop instruction for access to a stop target area, which has been used by a faulty information processing apparatus where a fault is detected among the other information processing apparatuses, to an information processing apparatus except for the faulty information processing apparatus in accordance with the management information; a setting processor that sets new authentication information to the authentication-information storage region that corresponds to each unit area of the stop target area; and second notifying processor that notifies the information processing apparatus, to which the stop instruction is notified by the first notifying processor, of the new authentication information and an instruction to resume access.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates the hardware configuration of an information processing system according to an embodiment;

FIG. 2 is a block diagram of a CPU chip;

FIG. 3 is a diagram that illustrates the logical configuration of the hardware and the functional configuration of the software of the information processing system according to the embodiment;

FIG. 4 is a diagram that illustrates an example of a management table;

FIG. 5 is a diagram that illustrates delivery of a token;

FIG. 6A is a first diagram that illustrates a method of making a notification again;

FIG. 6B is a second diagram that illustrates a method of making a notification again;

FIG. 7 is a flowchart that illustrates the flow of a process that uses a shared memory;

FIG. 8A is a flowchart that illustrates the flow of a process to determine a node, which uses the shared memory, on a per-segment basis;

FIG. 8B is a flowchart that illustrates the flow of a process to determine a process that uses the shared memory on a per-segment basis;

FIG. 9 is a flowchart that illustrates the flow of a process when a fault occurs in a node; and

FIG. 10 is a flowchart that illustrates the flow of a process when a fault occurs in an app.

### DESCRIPTION OF EMBODIMENT(S)

A preferred embodiment of the present invention will be explained with reference to accompanying drawings. Furthermore, the embodiment does not limit the disclosed technology.

First of all, terms used in the description of the embodiment will be described.

“Node” denotes an information processing device (a computer system), on which one or more operating systems (OS) run. In a computer system having a virtualization function, a node may be logically divided into plural logical domains to allow plural OSs to run on the node.

“Shared memory accessed by nodes” denotes a shared memory that is accessible (readable/writable) by plural nodes (plural applications that run on plural different OSs).

“Home node” denotes a node having a physical memory established as a memory area shared by nodes.

“Remote node” denotes a node that refers to or updates the memory of the home node.

“Segment” denotes a unit in which the shared memory is managed. A memory token, which will be described later, may be set for each segment.

“Segment size” denotes a size of the unit in which the shared memory is managed. For example, the size may be 4 megabytes (MB), 32 MB, 256 MB, or 2 gigabytes (GB).

“RA” denotes a real address. The real address is an address assigned to each logical domain in a system, in which a virtualization function is installed.

“PA” denotes a physical address. The physical address is an address assigned according to the physical position.

“Memory token” denotes a memory access key that is set in a memory token register of a CPU chip of the home node. A different memory token is set for each segment. The memory access key is also referred to as a token.

“Access token” denotes a memory access key that is set when a remote node accesses the shared memory of the home node (another one of the nodes).

Based on an access token added to a memory access request from a remote node and a memory token set in the memory token register of the home node, hardware controls whether or not the memory access request is executable.

When the memory token of the home node and the access token of the remote node match, the shared memory is accessible (readable and writable).

When the memory token of the home node and the access token of the remote node do not match and access (read and write) to the shared memory is attempted, an exception trap occurs and the shared memory becomes inaccessible.

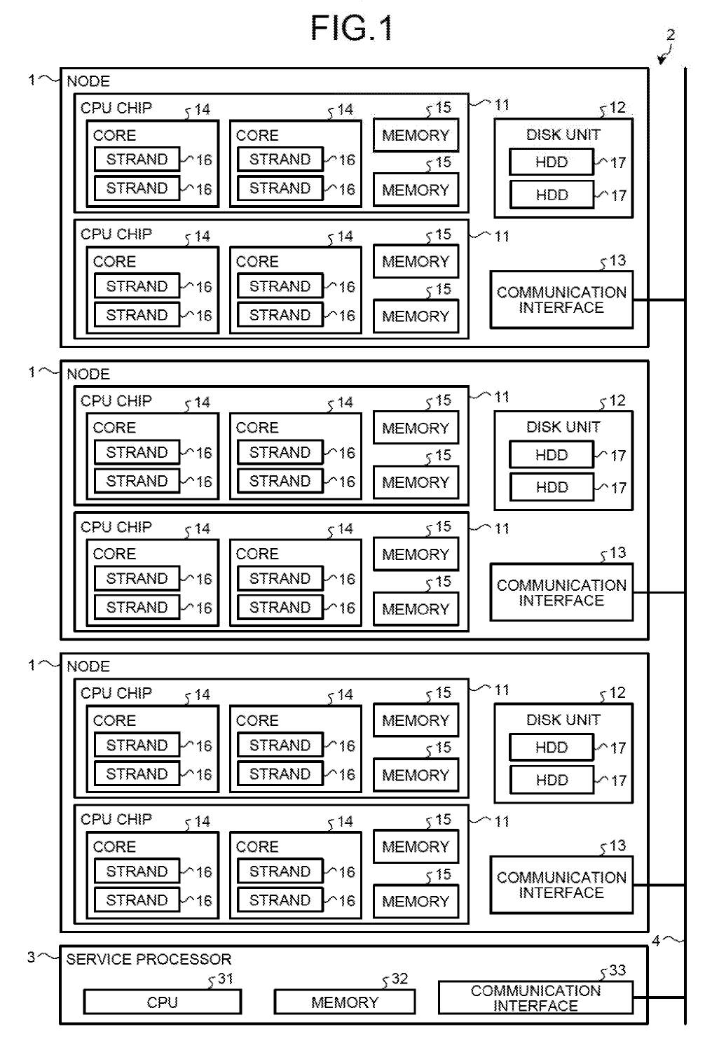

Next, an explanation is given of the hardware configuration of an information processing system according to the embodiment. FIG. 1 is a diagram that illustrates the hardware configuration of the information processing system according to the embodiment. As illustrated in FIG. 1, an information processing system 2 includes three nodes 1 and a service processor 3. Furthermore, the three nodes 1 and the service processor 3 are connected via a crossbar network 4.

The node 1 is an information processing apparatus that includes two CPU chips 11, a disk unit 12, and a communication interface 13. The CPU chip 11 is a chip that includes two cores 14 and two memories 15. The core 14 is a processing device that includes two strands 16. The strand 16 is a unit for executing an instruction in the core 14. A program is executed by each of the strands 16. The memory 15 is a random access memory (RAM) that stores programs executed by the core 14 and data used by the core 14.

The disk unit 12 is a storage device that includes two HDDs 17. The HDD 17 is a magnetic disk device. The communication interface 13 is an interface for communicating with the different node 1 and the service processor 3 via the crossbar network 4.

The service processor 3 is a device that controls the node 1, and it includes a CPU 31, a memory 32, and a communication interface 33. The CPU 31 is a central processing unit that executes programs stored in the memory 32. The memory 32 is a RAM that stores programs executed by the CPU 31, data used by the CPU 31, or the like. The communication interface 33 is an interface for communicating with the node 1 via the crossbar network 4.

Furthermore, although FIG. 1 illustrates the three nodes 1 for the convenience of explanation, the information processing system 2 may include any number of the nodes 1. Furthermore, although FIG. 1 illustrates the case where the node 1 includes the two CPU chips 11, the node 1 may include any number of the CPU chips 11. Furthermore, although FIG. 1 illustrates the case where the CPU chip 11 includes the two cores 14, the CPU chip 11 may include any number of the cores 14. Furthermore, although FIG. 1 illustrates the case where the core 14 includes the two strands 16, the core 14 may include any number of the strands 16. Furthermore, although FIG. 1 illustrates the case where the CPU chip 11 includes the two memories 15, the CPU chip 11 may include any number of the memories 15. Furthermore, although FIG. 1 illustrates the case where the disk unit 12 includes the two HDDs 17, the disk unit 12 may include any number of the HDDs 17.

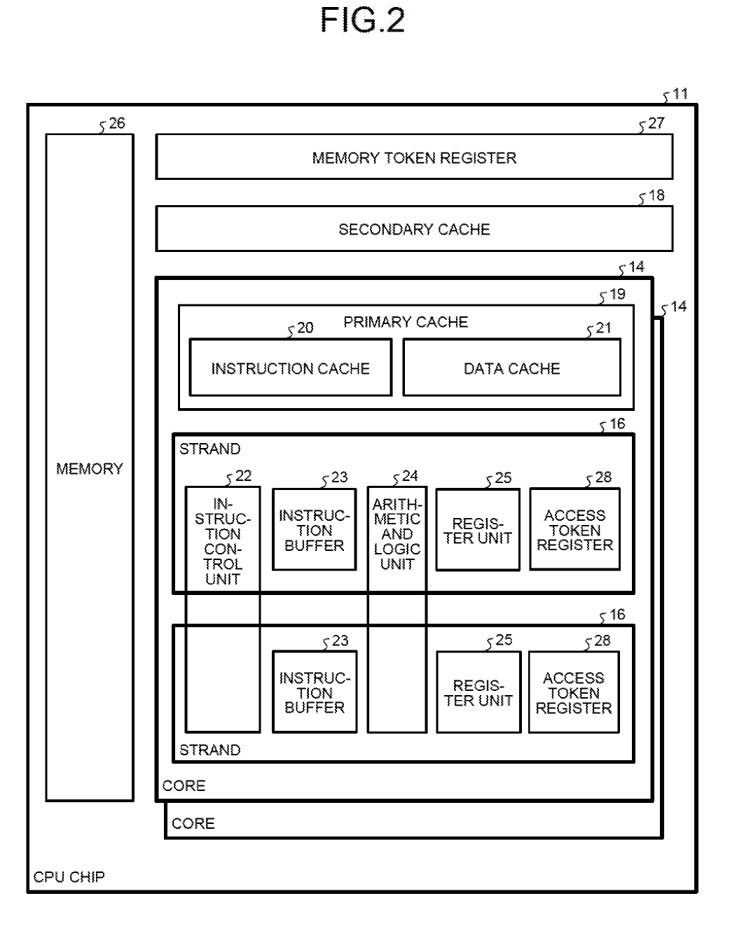

FIG. 2 is a block diagram of the CPU chip 11. As illustrated in FIG. 2, the CPU chip 11 includes two cores 14, a memory 26, a memory token register 27, and a secondary cache 18. Here, the memory 26 corresponds to the two memories 15 in FIG. 1.

The memory token register 27 stores a memory token for each segment. The secondary cache 18 is a cache device that includes a low-speed large-capacity cache memory as compared to a primary cache 19 in the core 14. The memory token register 27 and the secondary cache 18 are omitted from FIG. 1.

The core 14 includes the primary cache 19 and the two strands 16. The primary cache 19 is a cache device that includes a high-speed small-capacity cache memory as compared to the secondary cache 18. The primary cache 19 includes an instruction cache 20 and a data cache 21. The instruction cache 20 stores instructions, and the data cache 21 stores data.

The strand 16 reads instructions and data from the primary cache 19. If the primary cache 19 does not contain the instructions or the data that are read by the strand 16, the primary cache 19 reads the instructions or the data from the secondary cache 18. If the secondary cache 18 does not contain the instructions or the data that are read by the primary cache 19, the secondary cache 18 reads the instructions or the data from the memory 26.

Furthermore, the strand 16 writes data, which is to be stored in the memory 26, in the primary cache 19. After the data is written in the primary cache 19 by the strand 16, it is written in the secondary cache 18 and is then written in the memory 26 from the secondary cache 18.

The strand 16 includes an instruction control unit 22, an instruction buffer 23, an arithmetic and logic unit 24, a register unit 25, and an access token register 28. The instruction control unit 22 reads an instruction from the instruction buffer 23 and controls execution of the read instruction. The instruction buffer 23 stores an instruction that is read from the instruction cache 20. The arithmetic and logic unit 24 performs calculations such as four arithmetic operations. The register unit 25 stores data used for execution of instructions, execution results of instructions, or the like. Here, although the strand 16 includes the instruction buffer 23 and the register unit 25 of its own, the instruction control unit 22 and the arithmetic and logic unit 24 are shared by the two strands 16.

The access token register 28 stores the access token for each segment in the shared memory of the different node 1. During the process executed by the strand 16, the shared memory is accessed by using the access token stored in the access token register 28. The primary cache 19 and the access token register 28 are omitted from FIG. 1. Although the access token register 28 is included in the strand 16 in FIG. 2, the implementation of the access token register 28 is not limited to the example of FIG. 2, and each of the access token registers 28, corresponding to the strands 16, may be provided outside the strand 16.

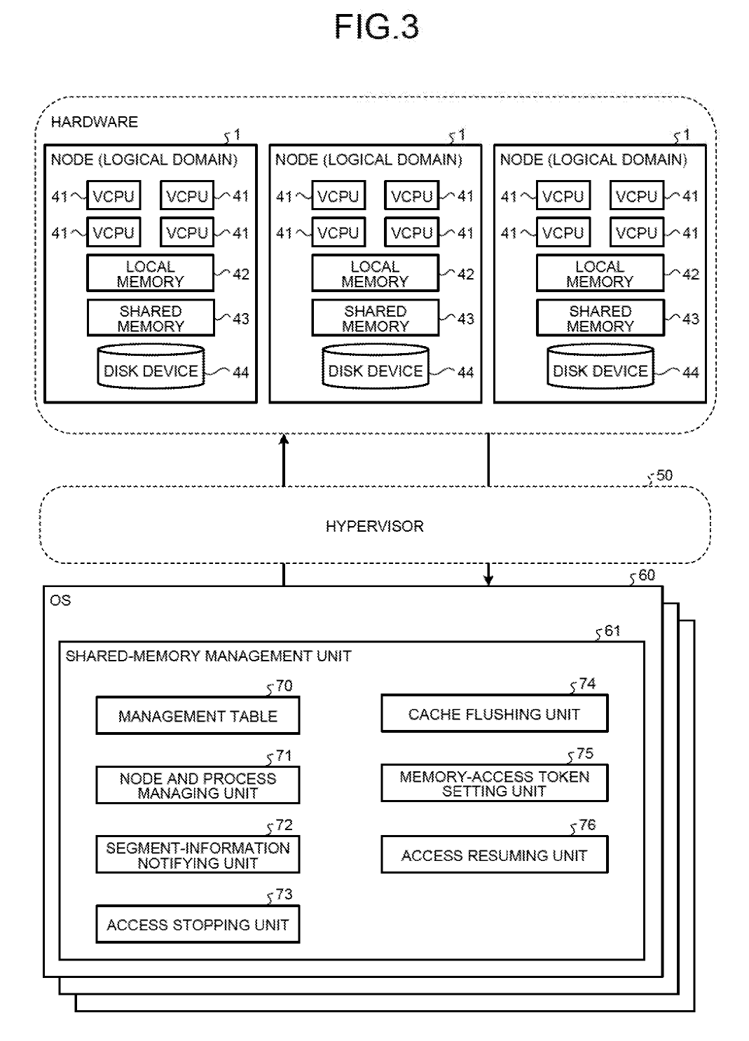

Next, an explanation is given of the logical configuration of the hardware and the functional configuration of the software of the information processing system 2 according to the embodiment. Here, the logical configuration of the hardware is the logical hardware that is used by the OS or an application. FIG. 3 is a diagram that illustrates the logical configuration of the hardware and the functional configuration of the software of the information processing system 2 according to the embodiment. FIG. 3 illustrates a case where each of the nodes 1 is used as one logical domain. One OS runs in one logical domain. Accordingly, in FIG. 3, one OS runs on each of the nodes 1.

As illustrated in FIG. 3, the node 1 includes, as logical resources, four VCPUs 41, a local memory 42, a shared memory 43, and a disk device 44. The VCPU 41 is a logical CPU, and it corresponds to any one of the eight strands 16 that are illustrated in FIG. 1.

The local memory 42 is a memory that is accessed by only its own node 1, and the shared memory 43 is a memory that may be also accessed by the different node 1. The local memory 42 and the shared memory 43 correspond to the four memories 15 that are illustrated in FIG. 1. The local memory 42 may correspond to the two memories 15 and the shared memory 43 may correspond to the other two memories 15, or the local memory 42 may correspond to the three memories 15 and the shared memory 43 may correspond to the other one memory 15. The disk device 44 corresponds to the disk unit 12 that is illustrated in FIG. 1.

A hypervisor 50 is basic software that manages the physical resources of the information processing system 2 and provides an OS 60 with logical resources. The OS 60 controls execution of an application by using logical resources. The OS 60 includes a shared-memory management unit 61.

The shared-memory management unit 61 manages the shared memory 43, and it includes a management table 70, a node and process managing unit 71, a segment-information notifying unit 72, an access stopping unit 73, a cache flushing unit 74, a memory-access token setting unit 75, and an access resuming unit 76.

The management table 70 is a table that registers information on the shared memory 43 on a per-segment basis with regard to all the shared memories 43 included in the information processing system 2, including the shared memory 43 included in the different node 1.

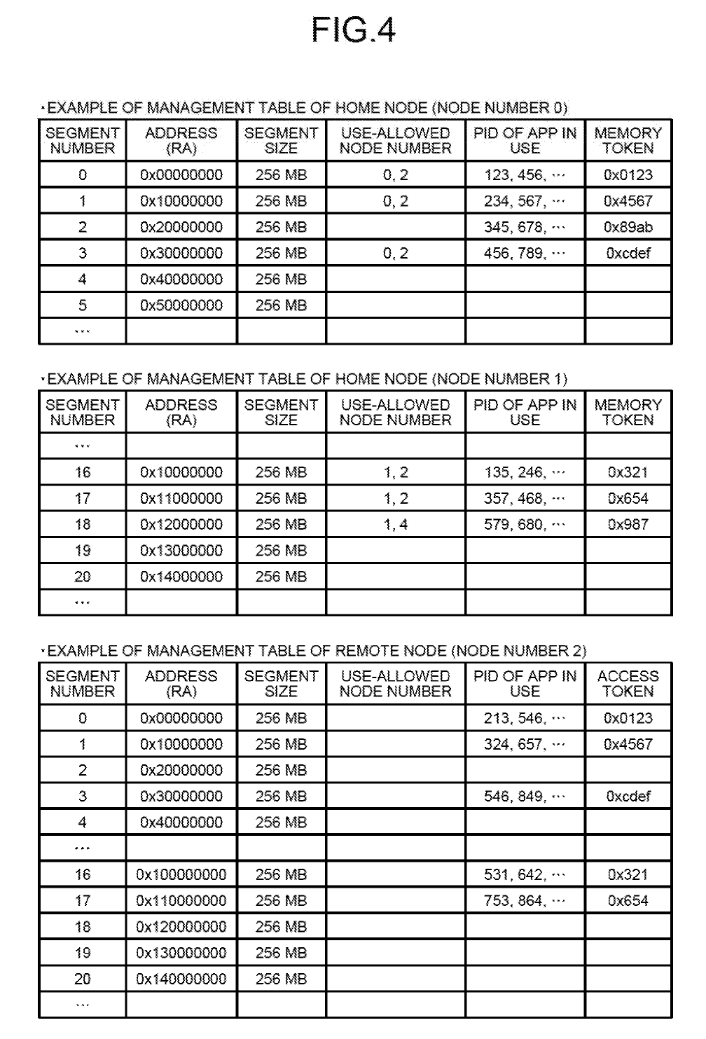

FIG. 4 is a diagram that illustrates an example of the management table 70. FIG. 4 illustrates the management table 70 included in the home node with the node number “0”, the management table 70 included in the home node with the node number “1”, and the management table 70 included in the remote node with the node number “2”. In FIG. 4, the segments with the segment numbers “0” to “5” are the segments whose physical memories are included in the home node with the node number “0”. Furthermore, the segments with the segment numbers “16” to “20” are the segments whose physical memories are included in the home node with the node number “1”.

As illustrated in FIG. 4, in the management table 70 of the home node with the node number “0” and “1”, the segment number, the address, the segment size, the use-allowed node number, the PID of the application in use, and the memory token are registered for each segment. Furthermore, substantially the same items as those in the management table 70 of the home node are registered in the management table 70 of the remote node with the node number “2”; however, the access token is registered instead of the memory token.

The segment number is an identification number for identifying a segment. The address is the RA of a segment. Here, the address may be a PA. The segment size is the size of a segment. The use-allowed node number is used in only the management table 70 of the home node, and it is a number of the node 1 for which a segment is allowed to be used.

The PID of the application in use is a process ID of an application that uses a segment in its own node. The memory token is a memory access key that is used to control access permission of a segment. The access token is a memory access key used when the shared memory 43 of the home node is accessed.

For example, in the management table 70 of the home node with the node number “0”, with regard to the segment with the identification number “0”, the RA is “00000000” in hexadecimal, the size is “256 MB”, and the numbers of the nodes 1, which are allowed to be used, are “0” and “2”. Furthermore, the segment with the identification number “0” is used by the process with the process ID of “123”, “456”, or the like, in the home node, and the memory access key is “0123” in hexadecimal.

Furthermore, in the management table 70 of the remote node with the node number “2”, with regard to the segment with the identification number “0”, the RA is “00000000” in hexadecimal, and the size is “256 MB”. Furthermore, with regard to the segment with the identification number “0”, because the segment is not of the shared memory 43, for which that remote node has a physical memory, the use-allowed node number is not used. Furthermore, the segment with the identification number “0” is used by the process with the process ID of “213”, “546”, or the like, in the remote node, and the memory access key is “0123” in hexadecimal. Furthermore, as the segment with the identification number “2” is not allowed to be used, there is no process ID of an application using the segment.

With reference back to FIG. 3, for each segment of the shared memory 43, the node and process managing unit 71 manages which of the nodes 1 is using the segment and which process is using the segment. Specifically, when the node and process managing unit 71 in the home node gives a remote node a permission to use the shared memory 43, it records the node number of the remote node, which uses the shared memory segment, in the management table 70. As it is the shared memory 43, there is a possibility that there are multiple remote nodes that use the shared memory 43, and the node and process managing unit 71 records all the node numbers each time it gives a permission to use the shared memory 43.

Furthermore, when the node and process managing unit 71 in each of the nodes 1 attaches the shared memory 43 to an application, it records the process ID of the application, which uses the shared memory 43, in the management table 70. As it is the shared memory 43, there is a possibility that there are multiple applications that use the shared memory 43, and the node and process managing unit 71 records all the process IDs each time the shared memory 43 is attached to an application.

Furthermore, if a notification of termination of use of the shared memory 43 is received from a remote node, or if a remote node is stopped, the node and process managing unit 71 in the home node deletes the record of the node number of the remote node from the management table 70. Furthermore, if a notification of termination of use of the shared memory 43 is received from an application, or if an application is terminated, the node and process managing unit 71 in each of the nodes 1 deletes the record of the process ID of the application from the management table 70.

If a fault is detected in a remote node, the segment-information notifying unit 72 uses the management table 70 to identify a normal remote node that uses a segment whose physical memory is owned by its node among the segments that have been used by the faulty node. Then, the segment-information notifying unit 72 notifies the identified remote node of the segment number of the segment of which the physical memory is owned by its node among the segments that have been used by the faulty node.

Furthermore, if a fault of an application is detected, the segment-information notifying unit 72 uses the management table 70 to identify a segment that has been used by the faulty application. Then, the segment-information notifying unit 72 notifies the home node of the fault of the application together with the segment number. Then, the segment-information notifying unit 72 in the home node uses the notified segment number and the management table 70 to identify a normal remote node that uses the segment, which has been used by the faulty application, and it notifies the identified remote node of the segment number. A fault of the node 1 or a fault of an application is detected if no response is received from the target node or the target application, or if it is difficult to communicate with the target node or the target application due to a problem of the network.

If the access stopping unit 73 receives a notification of the number of the segment that has been used by the faulty node, it uses the management table 70 to identify all the applications that use the segment with the notified segment number and stops all the identified applications. Alternatively, the access stopping unit 73 may notify all the identified applications of the segment number and stop the access to only the segment that has been used by the faulty node. If access to only the segment that has been used by the faulty node is stopped, the area where access is temporarily stopped may be localized on a per-segment basis, and access is continuously possible to the shared memory other than the segment that has been used by the faulty node. Therefore, if access to only the segment that has been used by the faulty node is stopped, the information processing system 2 may be less affected.

If the number of the segment, which has been used by the faulty application, is notified, the access stopping unit 73 uses the management table 70 to identify all the applications that use the segment with the notified segment number and stops all the identified applications. Alternatively, the access stopping unit 73 may notify the segment number to all the identified applications and stop access to only the segment that has been used by the faulty application.

The cache flushing unit 74 flushes cache on a per-segment basis immediately before the memory-access token setting unit 75, which is described later, changes the memory token. Specifically, the cache flushing unit 74 writes back the latest data, cached in the primary cache 19 or the secondary cache 18, to the shared memory 43. If a faulty node is detected, the cache flushing unit 74 flushes cache on the segment that has been used by the faulty node. If a faulty application is detected, the cache flushing unit 74 flushes cache on the segment that has been used by the faulty application. As the cache flushing unit 74 flushes cache on a per-segment basis immediately before the memory token is changed, access from a faulty node or a faulty application may be blocked while the cache coherency is retained.

If a fault is detected in a remote node, the memory-access token setting unit 75 sets, in the memory token register 27, a new token to the segment whose physical memory is owned by its node among the segments that have been used by the faulty node. Then, the memory-access token setting unit 75 transmits the new token to a normal remote node. Then, the shared-memory management unit 61 in the remote node sets the new token in the access token register 28. In this way, as the memory-access token setting unit 75 transmits the new token to the normal remote node, the normal node may continuously use the segment that has been used by the faulty node.

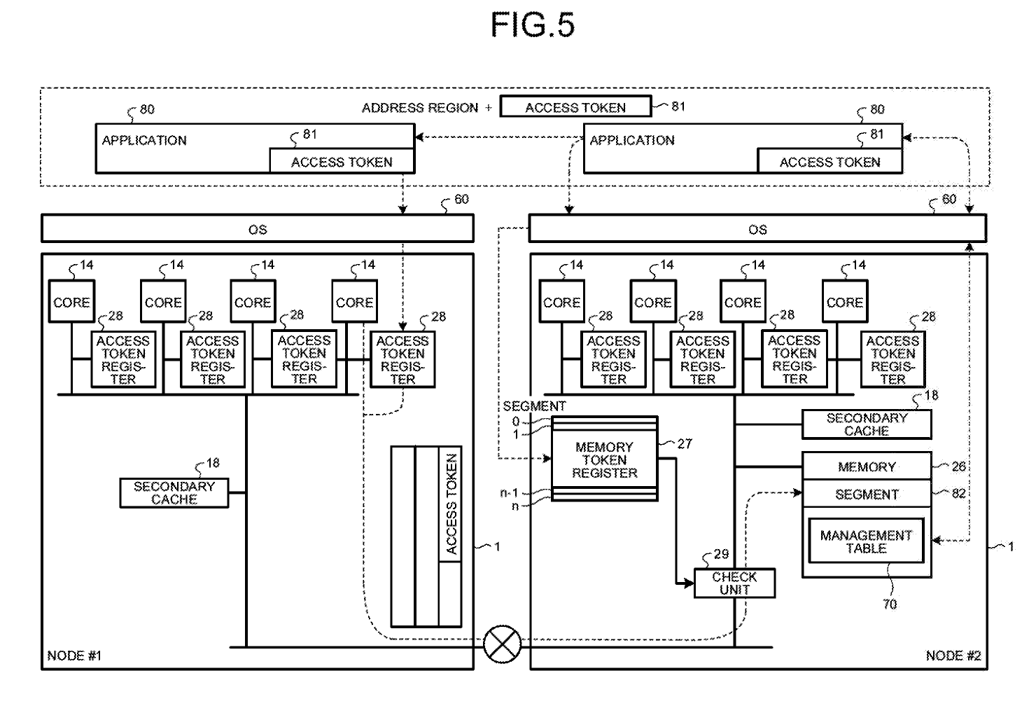

FIG. 5 is a diagram that illustrates delivery of the token. FIG. 5 illustrates a case where a node #1 accesses a segment 82 that is included in the shared memory 43 of a node #2. In FIG. 5, the core 14 includes the single strand 16, and the access token register 28 is related to the core 14. As illustrated in FIG. 5, the OS 60 of the node #2 registers the token, which is set in relation to the segment 82 in the memory token register 27, in the management table 70 in relation to the segment number and also delivers it to an application 80 that operates in the node #2.

The application 80 running in the node #2 transmits the token, delivered from the OS 60, as an access token 81 together with the information on the address region (address and size) to the application 80 that runs in the node #1 and accesses the segment 82. The application 80 running in the node #1 delivers the received access token 81 to the OS 60 running in the node #1. Then, the OS 60 running in the node #1 stores the access token 81 in the access token register 28.

The core 14 in the node #1 transmits information, including the access token 81, to the node #2 when the segment 82 is to be accessed. Then, a check unit 29 in the node #2 compares the memory token, stored in relation to the segment 82 in the memory token register 27, with the access token 81 and, if they match, allows access to the segment 82.

With reference back to FIG. 3, the access resuming unit 76 resumes access to the segment for which a new token has been set. The access resuming unit 76 in the home node notifies the normal remote node of access resumption. After the access resumption is notified, the access resuming unit 76 in the remote node resumes all the applications that are temporarily stopped. Alternatively, the access resuming unit 76 may make the application resume the access to the segment that is stopped being accessed by the access stopping unit 73, i.e., the segment to which the new access token 81 has been notified.

In this way, the memory-access token setting unit 75 in the home node sets a new memory token to the segment that has been used by a faulty node or a faulty application, and it notifies the set memory token to the normal remote node again. Then, the access resuming unit 76 in the home node notifies the normal remote node of access resumption. Therefore, the normal remote node may continuously access the segment that has been used by the faulty node or the faulty application. Conversely, the node 1, in which a fault occurs, or the faulty application is not allowed to access the segment that has been used by the faulty node or the faulty application.

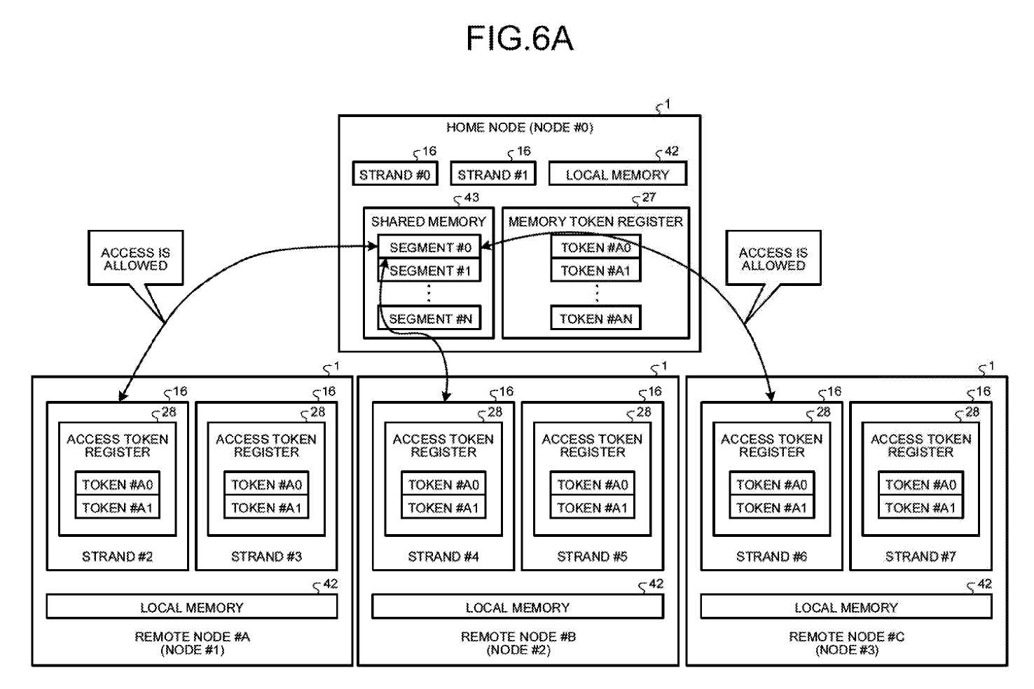

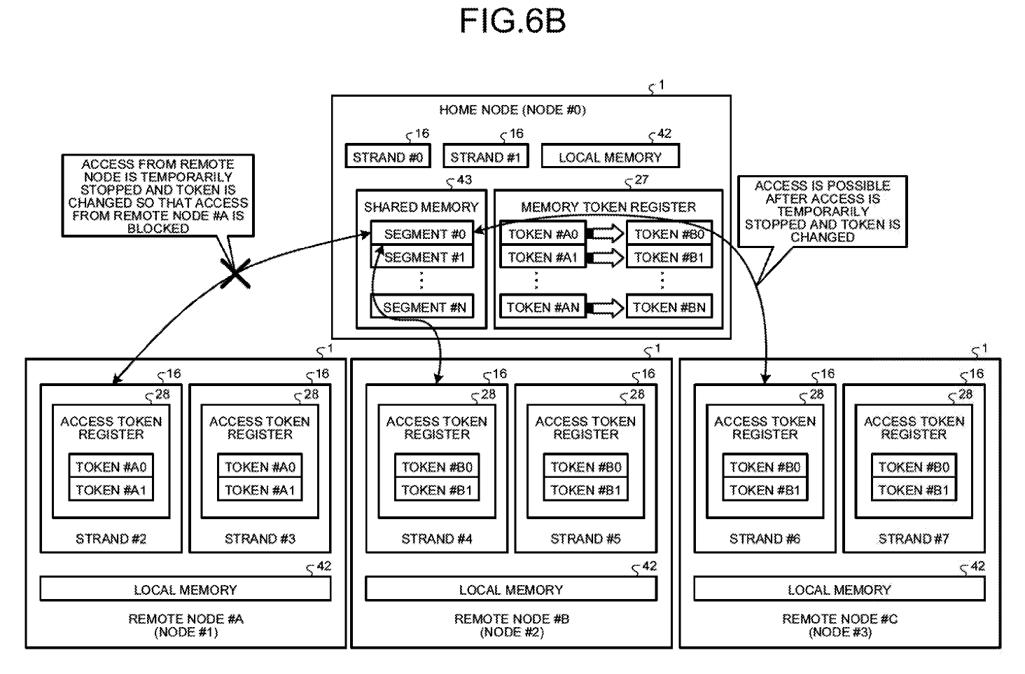

FIGS. 6A and 6B are diagrams that illustrate the method of making a notification again as described above. FIG. 6A illustrates a state before a token is notified again, and FIG. 6B illustrates a state after a token is notified again. In FIGS. 6A and 6B, a node #0 is the home node, and a node #1 to a node #3 are a remote node #A to a remote node #C. Furthermore, FIGS. 6A and 6B illustrate a case where each of the nodes 1 includes the single CPU chip 11 and each of the CPU chips 11 includes the single core 14. Furthermore, a segment #0 to a segment #N represent segments, and a token #A0 to a token #AN and a token #B0 to a token #BN represent tokens.

As illustrated in FIG. 6A, before a token is notified again, in the home node, the segment #0 is related to the token #A0, the segment #1 is related to the token #A1, and the segment #N is related to the token AN. Furthermore, the three remote nodes are allowed to access the segment #0 and the segment #1, and each of the access token registers 28 stores the token #A0 and the token #A1 in relation to the segment #0 and the segment #1. Each of the remote nodes is capable of accessing the segment #0 and the segment #1 by using the access token stored in the access token register 28.

If a failure occurs in the remote node #A, as illustrated in FIG. 6B, the memory tokens, corresponding to the segment #0 to the segment #N, are changed into the token #B0 to the token #BN, respectively, in the home node. Then, the token #B0 and the token #B1 are notified to the remote node #B and the remote node #C, and the access token registers 28 in the remote node #B and the remote node #C are rewritten. Conversely, as the token #B0 and the token #B1 are not notified to the remote node #A, the access token register 28 in the remote node #A is not rewritten.

Therefore, if the remote node #B and the remote node #C are notified of access resumption, they may access the segment #0 and the segment #1; however, accesses to the segment #0 and the segment #1 by the remote node #A are blocked.

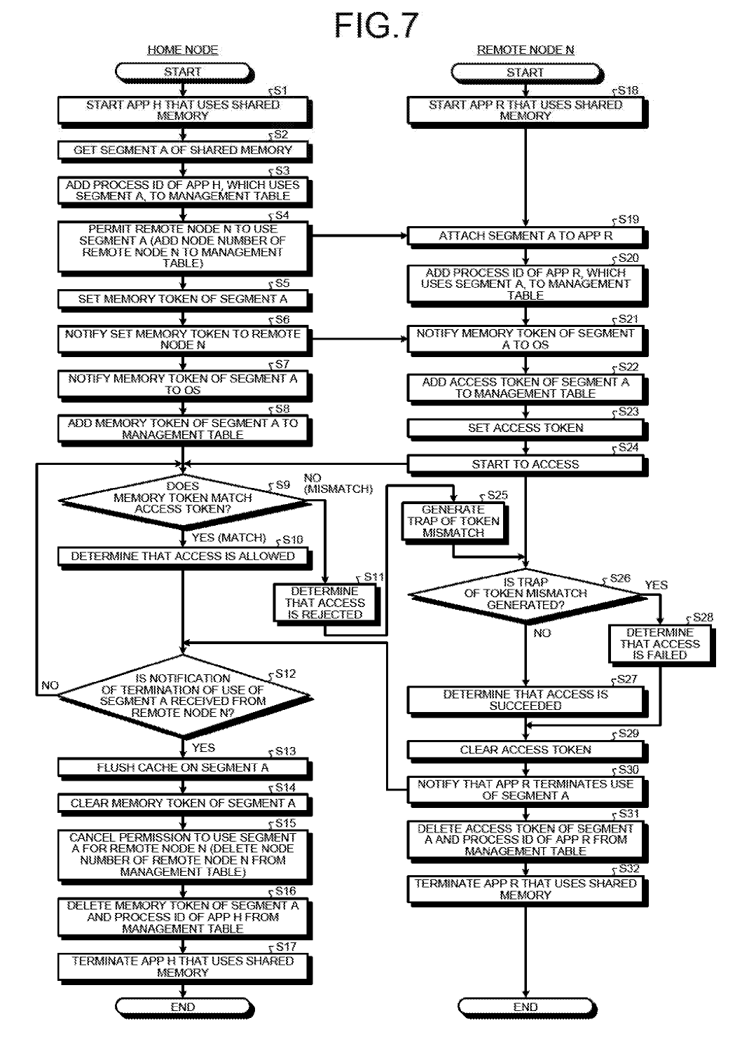

Next, an explanation is given of the flow of the process that uses the shared memory 43. FIG. 7 is a flowchart that illustrates the flow of the process that uses the shared memory 43. As illustrated in FIG. 7, in the home node, the OS 60 starts an app H that is an application that uses the shared memory 43 (Step S1). Then, the application H gets a segment A of the shared memory 43 (Step S2). Then, the node and process managing unit 71 in the home node adds the process ID of the application H, which uses the segment A, to the management table 70 (Step S3).

Then, the home node permits a remote node N to use the segment A of the shared memory 43, and it notifies the remote node N of the permission to use the segment A (Step S4). Here, the node and process managing unit 71 in the home node adds the node number of the remote node N, which uses the segment A, to the management table 70.

Meanwhile, in the remote node N, the OS 60 starts an app R that uses the shared memory 43 (Step S18). Then, if the permission to use the segment A is notified by the home node, the shared-memory management unit 61 in the remote node N attaches the segment A to the application R (Step S19). Furthermore, the node and process managing unit 71 in the remote node N adds the process ID of the application R, which uses the segment A, to the management table 70 (Step S20).

Then, the home node sets a memory token of the segment A (Step S5) and notifies the memory token of the segment A to the remote node N (Step S6). Then, the home node notifies the memory token of the segment A to the OS 60 (Step S7), and the OS 60 adds the memory token of the segment A to the management table 70 (Step S8).

Meanwhile, after the memory token of the segment A is notified by the home node, the application R in the remote node N notifies the memory token of the segment A to the OS 60 (Step S21). Then, the shared-memory management unit 61 in the remote node N adds the access token of the segment A to the management table 70 (Step S22) and sets the access token in the access token register 28 (Step S23). Then, the application R in the remote node N starts to access the segment A (Step S24).

After access to the segment A is received, the check unit 29 in the home node determines whether the memory token of the segment A matches the access token (Step S9) and, if they match, determines that access is allowed (Step S10). Conversely, if they do not match, the check unit 29 determines that access is rejected (Step S11) and notifies access rejection to the remote node N. If access rejection is notified, the remote node N generates a trap of token mismatch (Step S25).

The remote node N determines whether a trap of token mismatch is generated (Step S26) and, if it is not generated, determines that access is succeeded (Step S27), and if it is generated, determines that access is failed (Step S28). Afterward, the remote node N clears the access token (Step S29) and notifies that the application R terminates use of the segment A (Step S30).

The home node determines whether a notification of termination of use of the segment A is received from the remote node N (Step S12) and, if no notification is received, returns to Step S9. Conversely, if a notification is received, the cache flushing unit 74 flushes cache on the segment A (Step S13). Then, the home node clears the memory token of the segment A (Step S14), and the node and process managing unit 71 cancels the permission to use the segment A for the remote node N (Step S15). Specifically, the node and process managing unit 71 deletes the node number of the remote node N from the management table 70.

Then, the node and process managing unit 71 deletes the memory token of the segment A and the process ID of the application H from the management table 70 (Step S16). Then, the home node terminates the application H that uses the shared memory 43 (Step S17).

Meanwhile, the node and process managing unit 71 in the remote node N deletes the access token of the segment A and the process ID of the application R from the management table 70 (Step S31). Then, the remote node N terminates the application R that uses the shared memory 43 (Step S32).

In this way, the node and process managing unit 71 in the home node and the node and process managing unit 71 in the remote node N determine the node number of the node 1, which uses the segment A, and the process ID of the process in cooperation with each other. Therefore, if a failure occurs in the node 1 or the application that uses the segment A, the access stopping unit 73 in the home node for the segment A may request the remote node, which uses the segment A, to stop using the segment A.

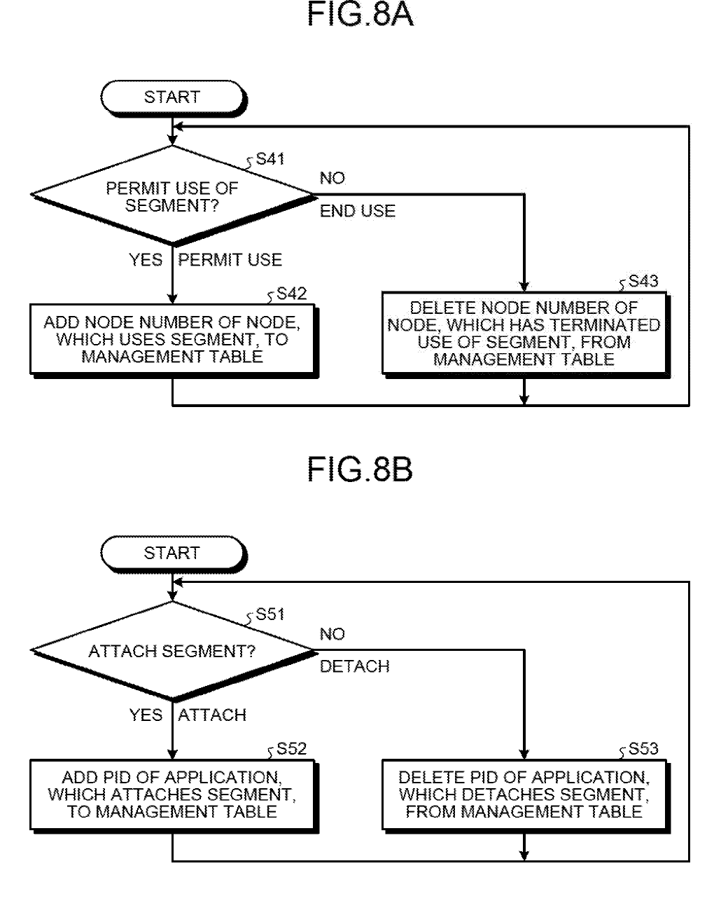

Next, an explanation is given of the flow of the process to determine the node 1 that uses the shared memory 43 on a per-segment basis. FIG. 8A is a flowchart that illustrates the flow of the process to determine the node 1, which uses the shared memory 43, on a per-segment basis.

As illustrated in FIG. 8A, the node and process managing unit 71 in the home node determines whether it is when the remote node is permitted to use a segment of the shared memory 43 (Step S41). As a result, if it is when the remote node is permitted to use the segment of the shared memory 43, the node and process managing unit 71 in the home node adds the node number of the node 1, which uses the segment, to the management table 70 (Step S42).

Conversely, if it is not when the remote node is permitted to use the segment of the shared memory 43, i.e., if the use is terminated, the node and process managing unit 71 in the home node deletes the node number of the node 1, which has terminated the use of the segment, from the management table 70 (Step S43).

In this way, the node and process managing unit 71 in the home node uses the management table 70 to manage the node number of the node 1 that uses a segment, thereby determining the remote node that uses the segment.

Next, an explanation is given of the flow of the process to determine the process that uses the shared memory 43 on a per-segment basis. FIG. 8B is a flowchart that illustrates the flow of the process to determine the process that uses the shared memory 43 on a per-segment basis.

As illustrated in FIG. 8B, the node and process managing unit 71 in the remote node determines whether it is when a segment is attached (Step S51). As a result, if it is when a segment is attached, the node and process managing unit 71 in the remote node adds the PID of the application, which attaches the segment, to the management table 70 (Step S52).

Conversely, if it is not when a segment is attached, i.e., if it is detached, the node and process managing unit 71 in the remote node deletes the PID of the application, which detaches the segment, from the management table 70 (Step S53).

In this way, the node and process managing unit 71 in the remote node uses the management table 70 to manage the PID of the application that uses a segment, thereby determining the application that uses the segment.

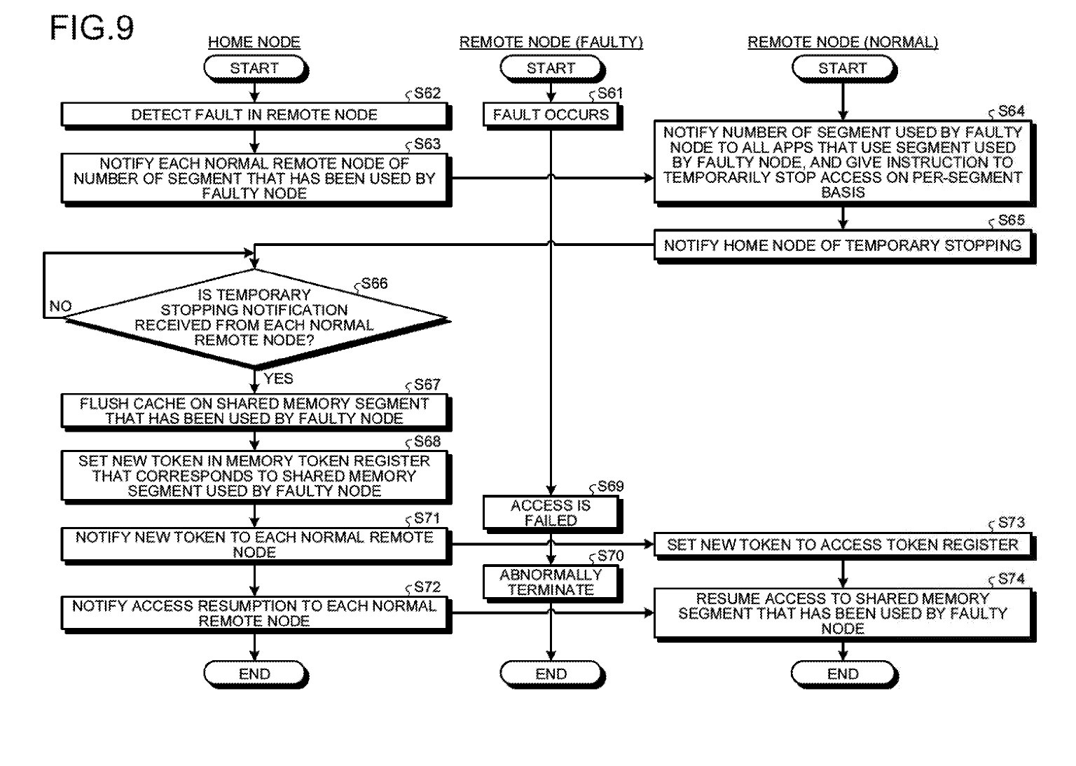

Next, an explanation is given of the flow of a process when a fault occurs in a node. FIG. 9 is a flowchart that illustrates the flow of the process when a fault occurs in a node. As illustrated in FIG. 9, a fault occurs in the remote node (Step S61), and the home node detects the fault in the remote node (Step S62). Then, the segment-information notifying unit 72 in the home node notifies each normal remote node of the number of the segment of the shared memory 43 that has been used by the faulty node (Step S63).

Then, the access stopping unit 73 in each of the normal remote nodes notifies the number of the segment used by the faulty node to all the applications that use the segment used by the faulty node, and it gives an instruction to temporarily stop access on a per-segment basis (Step S64). Then, the access stopping unit 73 notifies the home node of temporary stopping (Step S65).

Then, the home node determines whether a temporary stopping notification is received from each of the normal remote nodes (Step S66) and, if there is a remote node from which it is not received, repeatedly determines whether a temporarily stopping notification is received. Conversely, if a temporary stopping notification is received from each of the normal remote nodes, the cache flushing unit 74 flushes cache on the shared memory segment that has been used by the faulty node (Step S67).

Then, the memory-access token setting unit 75 sets a new token in the memory token register 27 that corresponds to the shared memory segment used by the faulty node (Step S68). Afterward, if the faulty node tries to access the shared memory segment, which has been used before the fault occurs, the access is failed (Step S69) and the faulty node is abnormally terminated (Step S70).

The memory-access token setting unit 75 in the home node notifies a new token to each of the normal remote nodes (Step S71), and the access resuming unit 76 in the home node notifies access resumption to each of the normal remote nodes (Step S72). Then, the memory-access token setting unit 75 in each of the normal remote nodes sets a new token to the access token register 28 (Step S73). Then, the access resuming unit 76 in each of the normal remote nodes resumes access to the shared memory segment that has been used by the faulty node (Step S74).

In this way, the home node sets a new memory token to the shared memory segment, used by a faulty node, and notifies it to each of the normal remote nodes, whereby access from a normal node may be permitted, and access from a faulty node may be prevented.

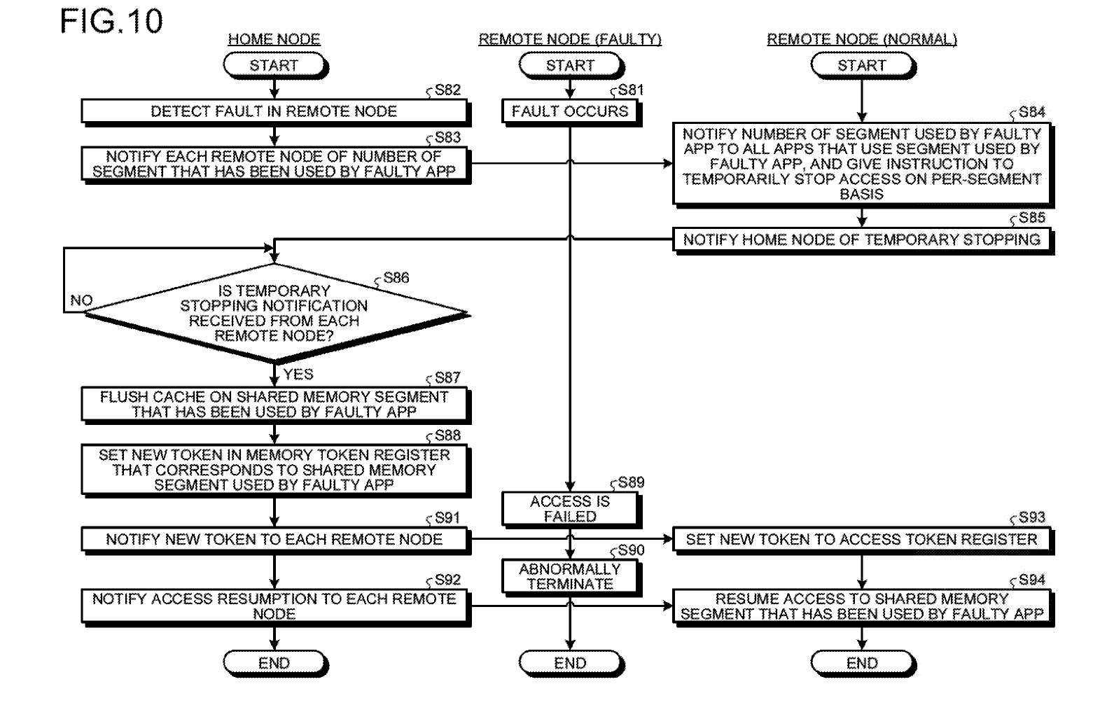

Next, an explanation is given of the flow of a process when a fault occurs in an app. FIG. 10 is a flowchart that illustrates the flow of the process when a fault occurs in an app. As illustrated in FIG. 10, a fault occurs in a remote app (Step S81), and the home node detects the fault in the remote app (Step S82). Then, the segment-information notifying unit 72 in the home node notifies each remote node of the number of the segment of the shared memory 43 that has been used by the faulty app (Step S83).

Then, the access stopping unit 73 in each remote node notifies the number of the segment used by the faulty app to all the applications that use the segment used by the faulty app, and it gives an instruction to temporarily stop access on a per-segment basis (Step S84). Then, the access stopping unit 73 notifies the home node of temporarily stopping (Step S85).

Then, the home node determines whether a temporary stopping notification is received from each of the remote nodes (Step S86) and, if there is a remote node from which it is not received, repeatedly determines whether a temporary stopping notification is received. Conversely, if a temporary stopping notification is received from each of the remote nodes, the cache flushing unit 74 flushes cache on the shared memory segment that has been used by the faulty app (Step S87).

Then, the memory-access token setting unit 75 sets a new token to the memory token register 27 that corresponds to the shared memory segment that has been used by the faulty app (Step S88). Afterward, if the faulty app tries to access the shared memory segment, which has been used before the fault occurs, the access is failed (Step S89), and the faulty app is abnormally terminated (Step S90).

The memory-access token setting unit 75 in the home node notifies each remote node of the new token (Step S91), and the access resuming unit 76 in the home node notifies each remote node of access resumption (Step S92). Then, the memory-access token setting unit 75 in each remote node sets a new token to the access token register (Step S93). Then, the access resuming unit 76 in each remote node resumes access to the shared memory segment that has been used by the faulty app (Step S94).

In this way, the home node sets a new memory token to the shared memory segment, which has been used by a faulty app, and notifies it to each remote node, whereby access from an app other than the faulty app may be permitted, and access from the faulty app may be prevented.

As described above, according to the embodiment, the segment-information notifying unit 72 in the home node notifies each of the normal remote nodes of the number of the segment of the shared memory 43, which has been used by a faulty node, and it gives an instruction to temporarily stop access on a per-segment basis. Then, the memory-access token setting unit 75 sets a new token in the memory token register 27 that corresponds to the shared memory segment that has been used by the faulty node, and it notifies the new token to each of the normal remote nodes. Then, the access resuming unit 76 notifies access resumption to each of the normal remote nodes. Therefore, the normal node 1 is capable of continuously accessing the segments other than the shared memory segment that has been used by the faulty node without temporarily stopping access, whereby the normal node 1 may be prevented from being affected by failures.

Furthermore, according to the embodiment, before a new token is set, the cache flushing unit 74 flushes cache on the shared memory segment that has been used by a faulty node. Therefore, the home node may resume access to the shared memory segment, which has been used by the faulty node, while cache coherence is retained.

Furthermore, according to the embodiment, the access stopping unit 73 in each remote node notifies the number of the segment that has been used by a faulty node to all the applications that use the segment, which has been used by the faulty node, and it gives an instruction to temporarily stop access on a per-segment basis. Therefore, the information processing system 2 may prevent the application, which does not use the segment that has been used by the faulty node, from being affected by the fault in the node.

Furthermore, in the embodiment, an explanation is given of a case where the number of the node 1, which is allowed for usage, is registered in the management table 70; however, the CPU chip 11, the core 14, or the strand 16, which is allowed for usage, may be registered in the management table 70. In this case, the CPU chip 11, the core 14, or the strand 16 serves as an information processing apparatus.

Moreover, in the embodiment, an explanation is given of a case where, each time the application gets a segment, its use is allowed; however, if a certain area of the shared memory 43 is attached to the app, segments included in the attached shared memory 43 may be allowed to be used.

According to one aspect, on the normal information processing apparatus or the normal application, a process is performed to stop and resume the access to a unit area, which has been used by the fault-occurring information processing apparatus or the fault-occurring application, among the unit areas of the shared memory that is allowed to be used, while the normal information processing apparatus or the normal application is capable of continuously using the unit area that is not used by the fault-occurring information processing apparatus or the fault-occurring application.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus that constructs an information processing system together with other information processing apparatuses and that includes a shared memory accessed by the other information processing apparatuses, the information processing apparatus comprising:
a management-information storage region that stores management information in which each unit area of the shared memory is related to an information processing apparatus that is allowed to use each unit area;
an authentication-information storage region that stores authentication information that is used to control access authentication for each unit area of the shared memory;
a first notifying processor that notifies a stop instruction for access to a stop target area, which has been used by a faulty information processing apparatus where a fault is detected among the other information processing apparatuses, to an information processing apparatus except for the faulty information processing apparatus in accordance with the management information;
a setting processor that sets new authentication information to the authentication-information storage region that corresponds to each unit area of the stop target area; and
a second notifying processor that notifies the information processing apparatus, to which the stop instruction is notified by the first notifying processor, of the new authentication information and an instruction to resume access.

2. The information processing apparatus according to claim 1, further comprising a flushing processor that flushes cache on the stop target area before the setting processor sets new authentication information in the authentication-information storage region.

3. The information processing apparatus according to claim 1, wherein
the first notifying processor notifies a stop instruction for access to the stop target area to an application that uses any of the unit areas of the stop target area among applications that run in other information processing apparatuses except for the faulty information processing apparatus, and
the second notifying processor notifies the application, to which the stop instruction is notified by the first notifying processor, of the new authentication information and an instruction to resume access.

4. The information processing apparatus according to claim 1, wherein the faulty information processing apparatus is an information processing apparatus such that an application running on the information processing apparatus has a failure.

5. A shared-memory management method by an information processing apparatus that constructs an information processing system together with other information processing apparatuses and that includes a shared memory accessed by the other information processing apparatuses, the shared-memory management method comprising:
in accordance with management information in which each unit area of the shared memory is related to an information processing apparatus that is allowed to use each unit area,
notifying a stop instruction for access to a stop target area, which has been used by a faulty information processing apparatus where a fault is detected among the other information processing apparatuses, to an information processing apparatus except for the faulty information processing apparatus;
updating authentication information, corresponding to each unit area of the stop target area, to new authentication information; and
notifying the information processing apparatus, to which the stop instruction is notified, of the new authentication information and an instruction to resume access.

6. A non-transitory computer-readable recording medium having stored therein a program that is executed by an information processing apparatus that constructs an information processing system together with other information processing apparatuses and that includes a shared memory accessed by the other information processing apparatuses, the program causing a computer to execute a process comprising:
in accordance with management information in which each unit area of the shared memory is related to an information processing apparatus that is allowed to use each unit area,
notifying a stop instruction for access to a stop target area, which has been used by a faulty information processing apparatus where a fault is detected among the other information processing apparatus, to an information processing apparatus except for the faulty information processing apparatus;
updating authentication information, corresponding to each unit area of the stop target area, to new authentication information; and
notifying the information processing apparatus, to which the stop instruction is notified, of the new authentication information and an instruction to resume access.
